(19) United States
(12) Patent Application Publication
(10) Pub. No.: US 2016/0124270 A1
(43) Pub. Date: May 5, 2016

(54) ILLUMINATION DEVICE, DISPLAY DEVICE, AND TV RECEIVER

(71) Applicant: SHARP KABUSHIKI KAISHA, Osaka (JP)

(72) Inventor: Takaharu SHIMIZU, Osaka (JP)

(73) Assignee: Sharp Kabushiki Kaisha, Osaka (JP)

(21) Appl. No.: 14/896,312

(22) PCT Filed: Feb. 28, 2014
(86) PCT No.: PCT/JP2014/055025

§ 371 Date: Dec. 4, 2015

(30) Foreign Application Priority Data
Jun. 7, 2013 (JP) 2013-120763

(51) Int. Cl. G02F 1/1335; F21V 8/00

(52) U.S. Cl. CPC G02F 1/133615; G02B 6/0016

(57) ABSTRACT

The backlight device includes: a plurality of LEDs arranged in a row; and a light guide plate having, on the long-side side faces, light-entering faces into which light emitted from the plurality of LEDs enters, the light guide plate further having side faces that respectively abut the light-entering faces 20a. The light-entering faces have a plurality of recesses or protrusions on the light-entering faces 20, each of the plurality of recesses or protrusions having a shape of a prism that directs the light entering the prism toward one of the side faces that is closer to where the prism is located relative to a center of the light guide plate.

### TECHNICAL FIELD

The present invention relates to an illumination device, a display device, and a TV receiver.

### BACKGROUND ART

A liquid crystal display device such as a liquid crystal television separately requires a backlight device as an illumination device, because its display panel, a liquid crystal panel, does not emit light, for example. Backlight devices are generally categorized into a direct-lit type and an edge-lit type based on the lighting mechanism. To achieve further thickness reduction of the liquid crystal display device, it is preferable to use an edge-lit backlight device.

In an edge-lit backlight device, a case houses a light guide plate that guides the light emitted from light sources such as LEDs (light emitting diodes) toward a light-exiting surface, which is provided on one surface of the light guide plate. A light-entering face is provided on at least one of the end faces of the light guide plate, and a plurality of light sources are disposed opposing the light-entering face.

For design reasons and the like, there can be demand for reducing the size of the frame region in a backlight device, or in other words narrowing the frame region. Compared to a backlight device that does not have a narrowed frame region, a backlight device that has a narrowed frame region has a shorter distance between the light sources and the display region of a display surface. In such a backlight device, images of light emitted from the plurality of LEDs disposed opposing the light-entering face become easily recognizable. Reducing the pitch of the plurality of LEDs is effective in avoiding this phenomenon in the backlight device that has a narrowed frame region.

On the other hand, reducing the pitch of the plurality of LEDs causes the light emitted from each of the LEDs to overlap more toward the center than toward the edges of the light-entering face of the light guide plate. As a result, the amount of light toward the edges of the light-entering face becomes less than that toward the center of the light-entering face. This makes the edges of the display surface in the backlight device become relatively darker compared to the center of the display surface, which can make brightness distribution in the display surface uneven. Patent Document 1 discloses a backlight unit that aims to eliminate the unevenness in brightness distribution in the display surface, for example.

### RELATED ART DOCUMENT

### Patent Document

Patent Document 1: Japanese Patent Application Laid-Open Publication No. 2012-242649

### Problems to be Solved by the Invention

The backlight unit disclosed in Patent Document 1 above, however, eliminates the unevenness in brightness distribution in the display surface by providing between the light guide plate and the display surface an optical sheet capable of regulating brightness distribution in the entire display surface so as to be even. The optical sheet has a configuration that combines a plurality of substantially semispherical lenses and a plurality of geometric structures arranged in series. This configuration, however, makes the path the light travels in the optical sheet long, thereby lowering the usage efficiency of light.

### SUMMARY OF THE INVENTION

The technology disclosed in the present specification was made in view of the above-mentioned problems. The technology disclosed in the present specification aims to provide a technology that can improve the uniformity of brightness distribution in the display surface without lowering the usage efficiency of light.

### Means for Solving the Problems

The technology disclosed in the present specification relates to an illumination device, including: a plurality of light-emitting diodes arranged in a row; and a light guide plate having, on at least one end face thereof, a light-entering face into which light emitted from the plurality of light-emitting diodes enter, the light guide plate further having adjacent side faces that are adjacent to the light-entering face, wherein the light-entering face has a plurality of recesses or protrusions, the plurality of recesses or protrusions having a shape of a prism that directs the light entering the light-entering face relatively more toward the adjacent side faces than toward a center of the light guide plate.

In the illumination device described above, the light entering the light-entering face of the light guide plate travels toward either of the adjacent end faces by virtue of the recesses or protrusions. Thus, even when the distance between adjacent LEDs becomes shorter, the backlight device can inhibit the light from overlapping more toward the center than toward the edges of the light-entering face and can prevent or inhibit the brightness between the center and the edges of the light-exiting surface from becoming uneven, for example. The backlight device can also avoid the lowering of the usage efficiency of light because the device does not use a lens member or the like in the middle of the path of the light as described in the configuration of a conventional technology. As a result, the illumination device described above can improve the evenness of brightness distribution in the display surface without lowering the usage efficiency of light even when the distance between adjacent LEDs becomes shorter.

Each of the recesses or protrusions may be a prism lens that recesses in a triangular shape toward the center of the light guide plate in a plan view of the light guide plate, the prism lens extending in a direction orthogonal to a surface of the light guide plate, and wherein an apex of the triangular shape may be shifted in position relatively toward the adjacent side faces.

This configuration can provide specific shapes of the recesses or protrusions that make the light entering the light-entering face to travel relatively toward either of the adjacent end faces rather than toward the center of the light guide plate.

Each of the recesses or protrusions may be a prism lens that protrudes in a triangular shape toward an outer side of the light guide plate in a plan view of the light guide plate, the prism lens extending in a direction orthogonal to a surface of the light guide plate, and wherein an apex of the triangular shape may be shifted in position relatively toward the adjacent side faces.

This configuration can provide specific shapes of the recesses or protrusions that make the light entering the light-entering face travel relatively toward either of the adjacent end faces rather than toward the center of the light guide plate.

In each of the recesses or protrusions, of two sides that constitute the apex of the triangular shape in the plan view of the light guide plate, a side located relatively toward the adjacent side faces may be shorter than a side located relatively toward the center of the light guide plate.

This configuration can provide specific shapes of the recesses or protrusions that make the light entering the light-entering face travel relatively toward either of the adjacent end faces rather than toward the center of the light guide plate.

The recesses or protrusions may be provided on an entire surface of the light-entering face.

This configuration makes all of the light entering the light-entering face travel toward either of the adjacent end faces by virtue of the recesses or protrusions. Thus, the evenness of the brightness distribution in the display surface can be improved effectively.

In the light-entering face, the recesses or protrusions provided relatively toward the respective adjacent side faces may be more dense than the recesses or protrusions provided relatively toward the center of the light-entering face.

This configuration can make even more of the light entering the light-entering face relatively from the side of either of the adjacent end faces rather than the center of the light-entering face travel toward the corresponding adjacent end faces. Thus, the evenness of the brightness distribution in the display surface can be improved more effectively.

The recesses or protrusions are provided only on parts of the light-entering face located relatively toward the respective adjacent side faces.

According to this configuration, compared to when forming the recesses or protrusions on the entire surface of the light-entering face, the manufacturing cost of the light guide plate can be reduced.

The light guide plate may be made of a resin.

According to this configuration, when processing the light guide plate in a manufacturing process, the recesses or protrusions can be easily formed on the light-entering face by injection molding or the like.

The plurality of light-emitting diodes are arranged along the light-entering face in a straight line at a substantially uniform interval.

According to this configuration, the LEDs are disposed on the LED substrate or the like in a periodic manner in the manufacturing process of the backlight device. This arrangement of the LEDs is simpler compared to when the LEDs are disposed randomly. Thus, the operability in the manufacturing process of backlight devices can be improved.

The techniques disclosed in the present specification can be expressed as a display device including: the illumination device; and a display panel that performs display using light from the illumination device. A display device, in which the display panel is a liquid crystal panel that uses liquid crystal, is also novel and useful. A television receiver that includes the display device is also novel and useful.

### Effects of the Invention

The technology disclosed in the present specification can improve the evenness of brightness distribution in the display surface without lowering the usage efficiency of light.

### BRIEF DESCRIPTION OF THE DRAWINGS

FIG. 1 is an exploded perspective view of a television receiver TV according to Embodiment 1.

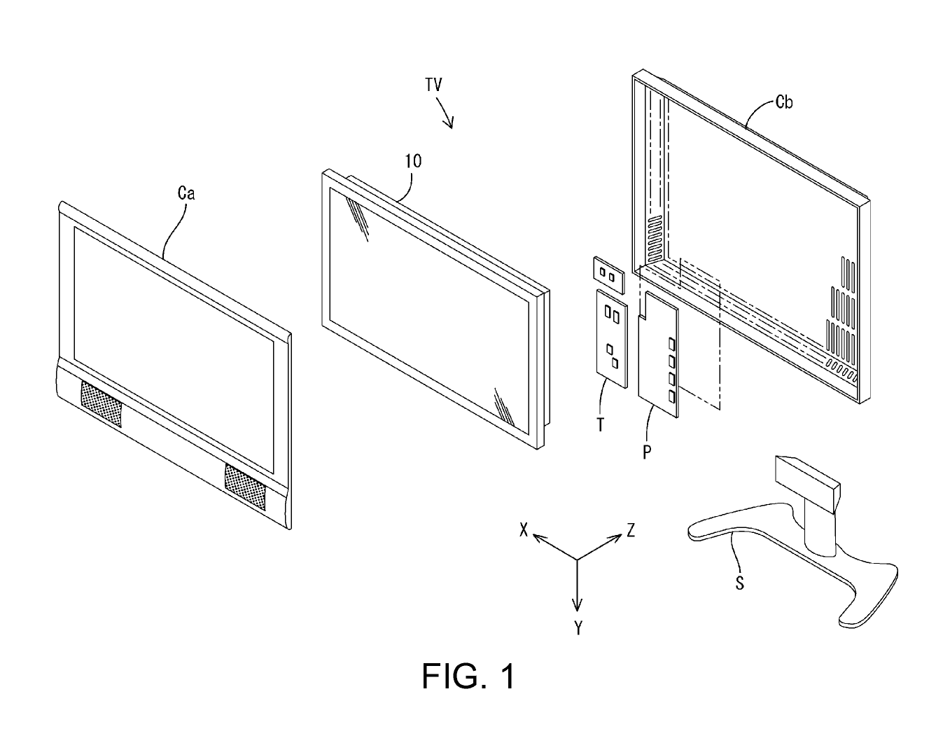

FIG. 2 is an exploded perspective view of a liquid crystal display device.

FIG. 3 is an exploded cross-sectional view that enlarged the part of the liquid crystal display device around the cross section of the LED that is cut along the short side direction of a chassis.

FIG. 4 is a plan view of a backlight device seen from the front side.

FIG. 5 is an enlarged plan view of an area around the LEDs in FIG. 4.

FIG. 6 is a plan view schematically showing the paths the light entering the light-entering face travels.

FIG. 7 is an enlarged plan view of an area around the LEDs in Embodiment 2.

FIG. 8 is a plan view of a backlight device seen from the front side in Embodiment 3.

FIG. 9 is an enlarged plan view of an area around the LEDs in Embodiment 3.

FIG. 10 is an enlarged plan view of an area around the LEDs in Embodiment 4.

### DETAILED DESCRIPTION OF EMBODIMENTS

### Embodiment 1

Embodiment 1 is described with reference to the drawings. In the present embodiment, a television receiver TV is described as an example. Each of the drawings indicates an X axis, a Y axis, and a Z axis in a portion of the drawings, and each of the axes indicates the same direction for the respective drawings. The Y axis direction corresponds to the vertical direction, and the X axis direction corresponds to the horizontal direction. Unless otherwise noted, “up” and “down” in the description is based on the vertical direction.

A television receiver TV includes a liquid crystal display device 10 (one example of a display device), front and rear cabinets Ca and Cb that house the liquid crystal display device 10 therebetween, a power source P, a tuner T, and a stand S. The liquid crystal display device 10 has a horizontally-long quadrilateral shape as a whole and includes a liquid crystal panel 16, which is a display panel, and a backlight device (an example of an illumination device) 24, which is an external light source. These are integrally held together by a component such as a bezel 12 having a frame-like shape. In the liquid crystal display device 10, the liquid crystal panel 16 is assembled with the display surface capable of displaying an image facing the front side.

Next, the liquid crystal panel 16 is described. In the liquid crystal panel 16, a pair of transparent (having a high degree of light transmission characteristics) glass substrates are bonded together with a prescribed gap therebetween, and a liquid crystal layer (not shown) is sealed between the glass substrates. One of the glass substrates is provided with switching elements (such as TFTs) connected to source lines and gate lines that intersect each other, pixel electrodes connected to the switching elements, an alignment film, and the like. The other glass substrate is provided with color filters including respective colored portions of R (red), G (green), B (blue), and the like, which are in a prescribed arrangement, an opposite electrode, an alignment film, and the like. Of these, the source lines, the gate lines, the opposite electrode, and the like are supplied with image data and various control signals from a driver circuit substrate (not shown) necessary for displaying an image. Polarizing plates (not shown) are disposed on the respective outer sides of the glass substrates.

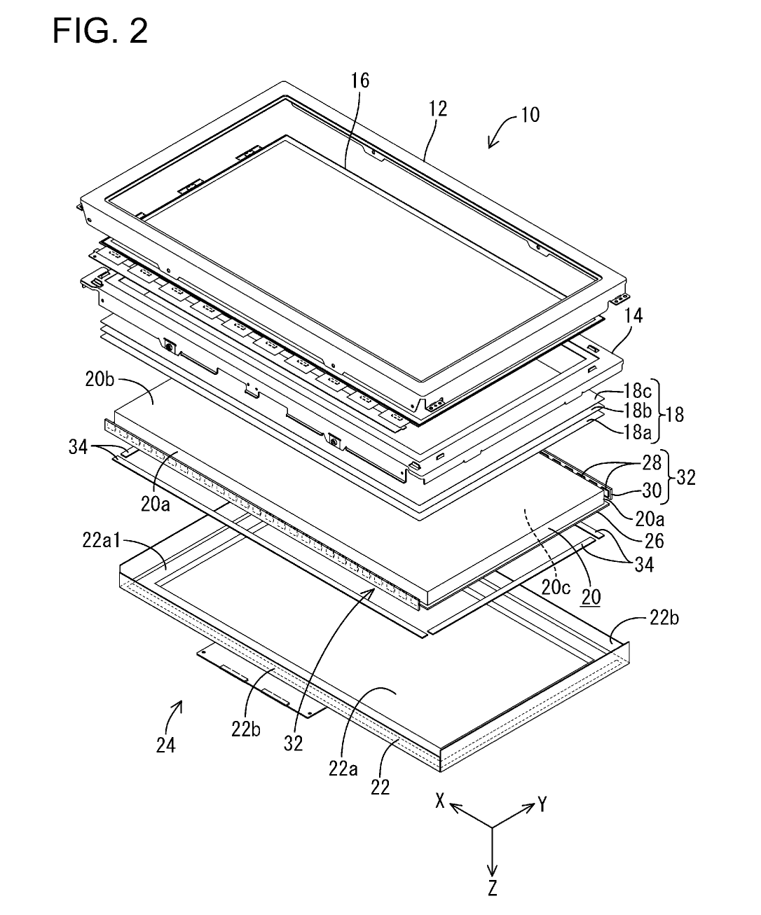

Next, the backlight device 24 is described. As shown in FIG. 2, the backlight device 24 includes an approximately box-shaped chassis 22 that is open on the front side (the light-emitting side, the liquid crystal panel 16 side), a frame 14 disposed on the front side of the chassis 22, and an optical member 18 disposed to cover the opening of the frame 14. Furthermore, the chassis 22 houses a pair of LED (light emitting diode) units 32 and 32, four spacers 34, a reflective sheet 26, and the light guide plate 20. Both side faces (light-entering faces) 20a on the long sides of the light guide plate 20 are disposed facing the respective LED units 32 and guide the light emitted from the LED units 32 toward the liquid crystal panel 16. The optical member 18 is placed on the front side of the light guide plate 20. The backlight device 24 of the present embodiment uses the so-called edge-lit method (side-lit method), in which the light guide plate 20 and the optical member 18 are disposed directly below the liquid crystal panel 16, and the LED units 32, which are the light sources, are disposed on the side edges of the light guide plate 20. Each component of the backlight device 24 is described in detail below.

The chassis 22 is made of a metal plate such as an aluminum plate or an electro-galvanized cold-rolled steel (SECC), for example. As shown in FIG. 2, the chassis 22 is constituted by a bottom plate 22a having a horizontally-long quadrangular shape similar to the liquid crystal panel 16, side walls 22b that rise from the respective outer edges of both of the long sides of the bottom plate 22a, and side walls that rise from the respective outer edges of both of the short sides of the bottom plate 22a. The space in the chassis 22 between the pair of LED units 32 is the space for housing the light guide plate 20 described later. The long side direction of the chassis 22 (the bottom plate 22a) corresponds to the X axis direction (horizontal direction), the short side direction to the Y axis direction (vertical direction). A frame-shaped (in a plan view) protruding section 22a1 that protrudes towards the light guide plate 20 is disposed on the edge areas of the surface of the bottom plate 22a. The top surface of the protruding section 22 is flat, and it is possible to place the light guide plate 20 along the edges thereof with the spacers 34 inserted therebetween. The protruding section 22a1 supports the light guide plate 20 and the reflective sheet 26, which are housed in the chassis 22, from the back side thereof. A control substrate (not shown) for providing a signal for driving the liquid crystal panel 16 is disposed on the outer back side of the bottom plate 22a. In a manner similar to the control substrate described above, other substrates such as an LED driver circuit substrate (not shown) that provides driving power to the LED units 32 are attached to the bottom plate 22a.

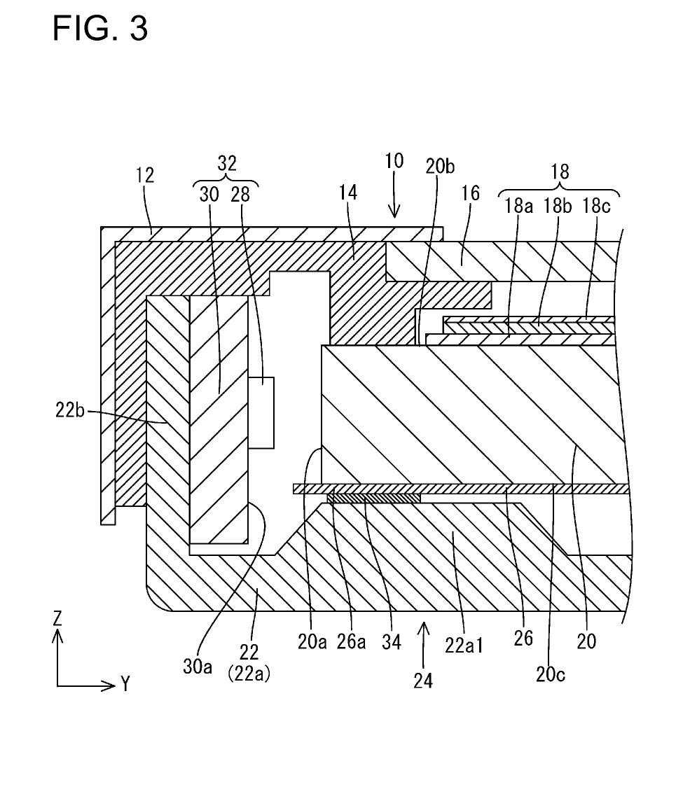

The frame 14 is made of a synthetic resin such as plastic. As shown in FIGS. 2 and 3, the frame is composed of two parts: a part that is parallel to the optical member 18 and the light guide plate 20 (the liquid crystal panel 16) and has an approximately frame-like shape in a plan view; and a part protruding toward the back side thereof from the periphery of the frame and having an approximately short tube-like shape. The part of the frame 14 that has an approximately frame-like shape extends along the periphery of the light guide plate 20 and can cover from the front side thereof almost the entire periphery of the optical member 18 and the light guide plate 20 disposed on the back side of the frame. At the same time, the part of the frame 14 having an approximately frame-like shape can receive (support) from the back side thereof almost the entire periphery of the optical member 18 disposed on the front side thereof. In other words, the part of the frame 14 having an approximately frame-like shape is interposed between the optical member 18 and the light guide plate 20. Also, one of the long sides of the part of the frame 14 having an approximately frame-like shape collectively covers from the front side the edge of the light guide plate 20 on the side of the light-entering face 20a and the LED units 32. The part of the frame 14 having an approximately short tube-like shape is attached by being appended to the outer surface of the side walls 22b of the chassis 22. The outer surface of the portion described above is disposed as to abut the inner surface of the tube-like surface of the bezel 12 described above.

The optical member 18 is constituted by stacking a diffusion sheet 18a, a lens sheet 18b, and a reflective polarizing plate 18c in this order from the light guide plate 20 side. The diffusion sheet 18a, the lens sheet 18b, and the reflective polarizing plate 18c change the light emitted from the LED units 32 and transmitted through the light guide plate 20 into planar light. The liquid crystal panel 16 is disposed on the upper side of the reflective polarizing plate 18d, and the optical member 18 is disposed in a stable manner being sandwiched between the frame 14 and the liquid crystal panel 16. In short, the optical member 18 is slightly larger than the inner edges of the frame 14 and disposed on the front surface of the inner edges thereof. Thus, as shown in the cross-sectional view in FIG. 3, the frame 14 separates the space formed between LEDs 28 and the light guide plate 20 from the edge of the optical member 18.

The reflective sheet 26 has the shape of a rectangular sheet, is made of a synthetic resin, and the surface thereof is white with excellent light-reflecting characteristics. The long side direction of the reflective sheet 26 corresponds to the X axis direction, the short side direction to the Y axis direction, and the reflective sheet 26 is sandwiched between the opposite surface 20c of the light guide plate 20 and the spacers 34 described later (see FIG. 3). The front side of the reflective sheet 26 has a reflective surface, and this reflective surface touches the opposite surface 20c of the light guide plate 20. The reflective sheet 26 can reflect light that has leaked from the LED units 32 or the light guide plate 20 toward the light reflecting surface of the reflective sheet 26. Also, the reflective sheet 26 is bigger than the opposite surface 20c of the light guide plate 20. As shown in FIGS. 2 and 3, the edges of the reflective sheet stick out slightly from the edges of the light guide plate 20.

The four spacers 34 are respectively arranged so as to be along both long directions and both short directions of the chassis 22. Each of the spacers has a flat plate-like shape. Each of the spacers 34 is placed on top of the protruding section 22a1 of the chassis 22. As described above, the edge areas of the reflective sheet 26 are sandwiched between the spacers 34 and the light guide plate 20. Having the reflective sheet sandwiched as described above fixes the reflective sheet 26 and limits the movement of the light guide plate 20 in the surface direction (the surface direction of the bottom plate 22a of the chassis 22, the X-Y plane surface direction). Having a portion of the outer edge portion of the reflective sheet 26 not sandwiched between the spacers 34 and the light guide plate 20 allows the portion of the outer edge portion to move in the surface direction of the light guide plate 20. In this configuration, the portion of the outer edge portion may eliminate wrinkles on the reflective sheet 26 caused by thermal expansion or the like.

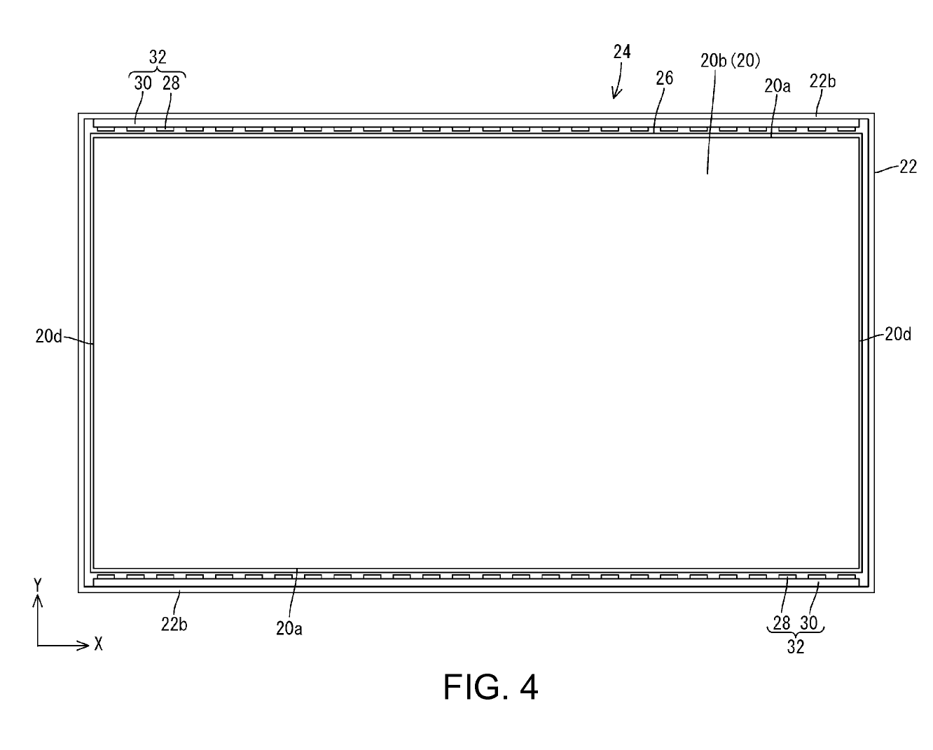

On each of the long sides of the chassis 22, a pair of the LED units 32 and 32 are provided in parallel along the long side direction of the chassis 22. Each of the LED units 32 is constituted by the LEDs 28 and a LED substrate 30. As shown in FIGS. 2 and 4, the LED substrate 30 that constitutes the LED unit 32 has a shape of a narrow plate extending along the long side direction (the X axis direction, the long side direction of the light-entering face 20a) of the light guide plate 20 and is housed inside the chassis 22 such that the plate surface thereof is parallel to both the X axis direction and the Z axis direction, or in other words, parallel to the light-entering face 20a of the light guide plate 20. The length in the long side direction (the X axis direction) of each of the LED substrates 30 is about as long as the length in the long side direction of the light guide plate 20. The LEDs 28 having the configuration described next are mounted on the inner surface of the LED substrate 30, or in other words the surface facing the light guide plate 20, and this surface is the mounting surface 30a. A wiring pattern (not shown) made of metal film (copper foil, for example) is formed on the mounting surface 30a of the LED substrate 30. The wiring pattern extends along the X axis direction and goes across the group of LEDs 28 connecting the adjacent LEDs 28 in series. By connecting to a power supply board via a wiring member such as a connector or a cable, terminals formed at the both ends of the wiring pattern supply driving power to each of the LEDs 28. The surface opposite to the mounting surface 30a of the LED substrate 30 is attached to the side wall 22b on the long side of the chassis 22 with screws or the like.

Each of the LEDs 28 that constitutes the LED unit 32 is made by sealing an LED element (not shown) by a resin on a substrate portion that is fixed to the LED substrate 30. The LED element mounted on the substrate portion has one primary wavelength, specifically emitting only blue light. On the other hand, phosphor that emits a prescribed color when excited by blue light emitted from the LED element is dispersed in the resin package that seals the LED element, and the LED element as a whole emits light that is largely white. For the phosphor, a yellow phosphor that emits yellow light, a green phosphor that emits green light, and a red phosphor that emits red light can be combined appropriately for use, or only one of the phosphors can be used, for example. The LEDs 28 are so-called top-emitting type, for which the primary light-emitting face is the surface opposite to the mounting surface 30a of the LED substrate 30 (the surface facing the light-entering face 20a of the light guide plate 20).

The light guide plate 20 is made of a synthetic resin (an acrylic resin such as PMMA or a polycarbonate, for example) that has a refractive index that is sufficiently higher than that of air and almost completely transparent (has excellent light transmission characteristics). As shown in FIG. 2, the light guide plate 20 has a horizontally-long quadrangular shape in a plan view, in a manner similar to the liquid crystal panel 16 and the chassis 22, and is shaped like a plate that is thicker than the optical sheet 18. The long side direction of the surface of the light guide plate 20 corresponds to the X axis direction, the short side to the Y axis direction, respectively, and the plate thickness direction intersecting with the surface corresponds to the Z axis direction. Each of the side faces on the long side of the light guide plate 20 is the light-entering face 20a that receives the light emitted from the LEDs 28. Recesses or protrusions 36 described later are provided on the light-entering face 20a. As shown in FIG. 4, both of the end faces on the short sides of the light guide plate 20, in other words both end faces that are adjacent to the light-entering face 20a are referred to as adjacent end faces 20d (side faces).

As shown in FIGS. 2 and 3, the light guide plate 20 is disposed such that the light-entering faces 20a face the LED units 32, the light-exiting surface 20b, which is the primary surface (the front surface), faces the optical sheet 18, and an opposite surface 20c, which is the surface opposite to a light-exiting surface 20b (the back surface), faces the reflective sheet 26. The light guide plate 20 is supported by the protruding portion 22a1 (described later) of the chassis 22 via the reflective sheet 26. The direction in which the light guide plate 20 aligns with the LED units 32 corresponds to the Y axis direction, and the direction the light guide plate aligns with the optical member 18 and the reflective sheet 26 is the Z axis direction. The light guide plate 20 has a function of receiving light emitted from the LED units 32 along the Y axis direction through the light-entering faces 20a, having the light travel therethrough while changing the direction of the light toward the optical member 18, and emitting the light through the light-exiting surface 20b.

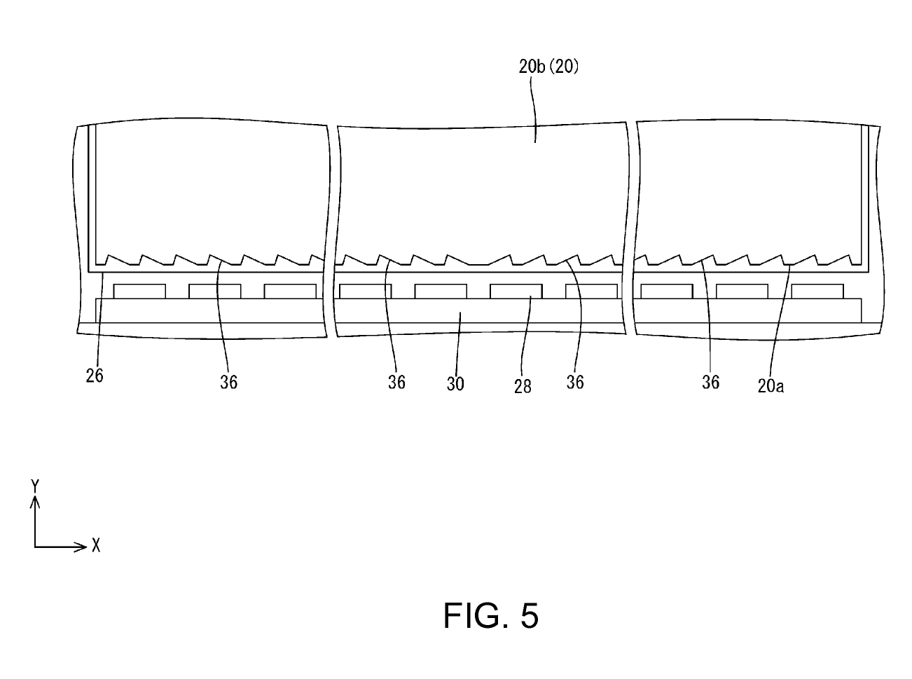

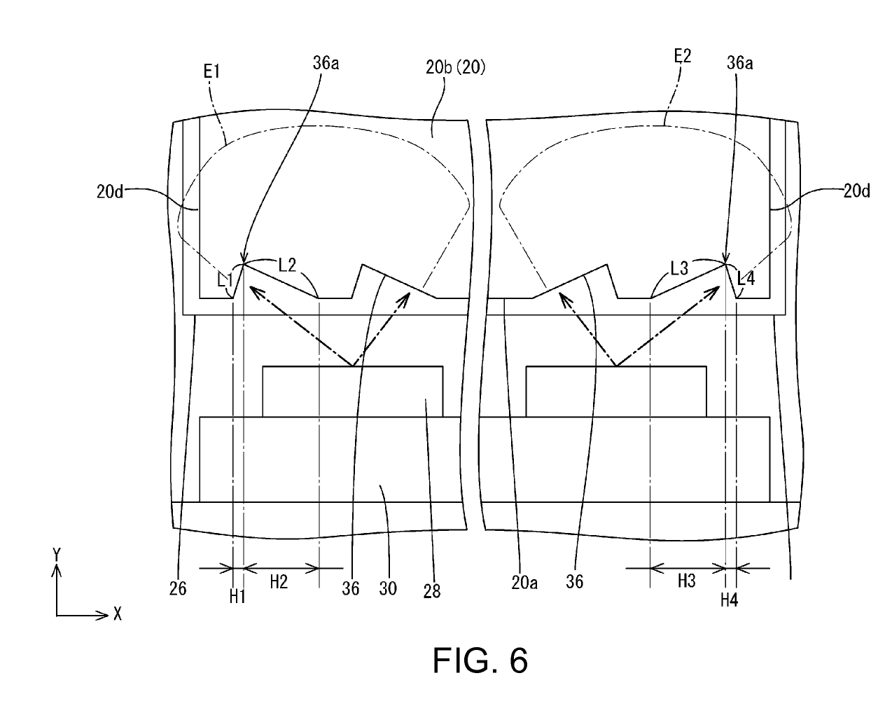

As shown in FIG. 5, a plurality of the recesses or protrusions 36 are provided on the entire surface of the light-entering face 20a of the light guide plate 20. The recesses or protrusions 36 are formed in prism shapes such that the light that is emitted by each of the LEDs 28 and that enters from the light-entering face 20a travels relatively more toward either of the adjacent end faces 20d than toward the center of the light guide plate 20. Specifically, as shown in FIG. 5, each of the recesses or protrusions 36 is a prism lens that extends in the direction orthogonal to the surface of the light guide plate 20 (the Z axis direction) and recesses in a triangular shape toward the center of the light guide plate 20. An apex 36a of this triangular shape of the prism lens is shifted in position relatively toward one of the adjacent end faces 20d (see FIG. 6).

As described above, the apex 36a of each of the recesses or protrusions 36 that constitute the prism lens is disposed in an uneven manner. FIG. 6 shows the two sides that constitute the apex 36a. As shown in the figure, the lengths of the sides L1 and L4, each of which is located relatively toward either one of the adjacent end faces 20d, are shorter than the length of the sides L2 and L3, each of which are located relatively toward the center of the light-entering face 20a. As shown in FIG. 6, three lines orthogonal to the light-entering face 20a are drawn. One is drawn from the apex 36a. The other two are drawn from the end opposite from the apex of each of the two sides that sandwiches the apex. In the configuration described above, the distances between the two straight lines that are located relatively toward either of the adjacent end faces 20d are defined as H1 and H4, and they are shorter than the distances between the two straight lines that are located relatively toward the center of the light-entering face 20a, which are defined as H2 and H3. Such recesses or protrusions 36 are formed in the manufacturing process of the light guide plate 20 by cutting an injection molding or a transparent resin by machining or the like.

Because each of the recesses or protrusions 36 provided on the light-entering face 20a has a shape described above, the light that is emitted from each of the LEDs 28 and enters from the light-entering face 20a propagates relatively toward the side of either of the adjacent end faces 20d rather than toward the center of the light guide plate 20, as shown by E1 and E2 in FIG. 6. This configuration can prevent the light from each of the LEDs 28 from overlapping more heavily in the central region of the light guide plate than in the regions toward the edges in the long side direction of the light guide plate 20. Because of this effect, even when the distance between each of the LEDs 28 becomes shorter, this configuration can control the in-plane brightness distribution in the light-exiting surface 20b so as to be substantially even in a plan view of the light guide plate 20.

As described above, in the backlight device 24 according to the present embodiment, the light entering the light guide plate 20 from the light-entering face 20a travels, by virtue of the recesses or protrusions 36, toward either one of the adjacent end faces 20d. Thus, even when the distances between adjacent LEDs 28 become shorter, the backlight device can inhibit the light from overlapping more in the center than in the edges of the light-entering face 20a, for example. As a result, the backlight device can prevent or inhibit the brightness between the center and the edges of the light-exiting surface 20b from becoming uneven. The backlight device can also avoid the lowering of the usage efficiency of light because the device does not use a lens member or the like in the middle of the path of the light as described in the configuration of a conventional technology. As a result, even when the distances between adjacent LEDs 28 become shorter, the backlight device 24 according to the present embodiment can improve the evenness of the brightness distribution in the light-exiting surface 20b without lowering the usage efficiency of light.

In the present embodiment, each of the recesses or protrusions 36 is a prism lens that extends in the direction orthogonal to the surface of the light guide plate 20 (the Z axis direction) and recesses in a triangular shape toward the center of the light guide plate 20 in a plan view of the light guide plate 20. The apex 26a of the triangular shape is shifted in position relatively toward one of the adjacent end faces 20d. Specifically, in the plan view of the light guide plate 20, each of the recesses or protrusions 36 has two sides that form the apex 26a of the triangular shape. Of this triangular shape, the side located relatively toward either of the adjacent end faces 20d is shorter than the side located relatively toward the center of the light-entering face 20a. As described above, the present embodiment provides a specific form of the recesses or protrusions 36 that guides the light entering from the light-entering face 20a to travel relatively toward either of the end faces 20d than toward the center of the light guide plate 20.

In the present embodiment, the recesses or protrusions 36 are provided on the entire surface of the light-entering face 20a. This configuration enables, by virtue of the recesses or protrusions 36, all of the light entering from the light-entering face 20a to travel toward either of the adjacent end faces 20d. Thus, this backlight device can improve the evenness of the brightness distribution in the light-exiting surface 20b effectively.

In the present embodiment, the light guide plate 20 is made of a synthetic resin. Thus, when processing the light guide plate 20 in a manufacturing process, the recesses or protrusions 36 can be easily formed on the light-entering face 20a by injection molding or the like.

Also, in the present embodiment, a plurality of the LEDs 28 are formed in a straight line along the light-entering face 20a with a substantially uniform pitch. In such a configuration, the LEDs 28 are disposed on the LED substrate 30 or the like in a periodic manner in the manufacturing process of the backlight device 24. This arrangement of the LEDs 28 is simpler compared to when the LEDs 28 are disposed randomly. Thus, the operability in the manufacturing process of the backlight device 24 can be improved.

### Embodiment 2

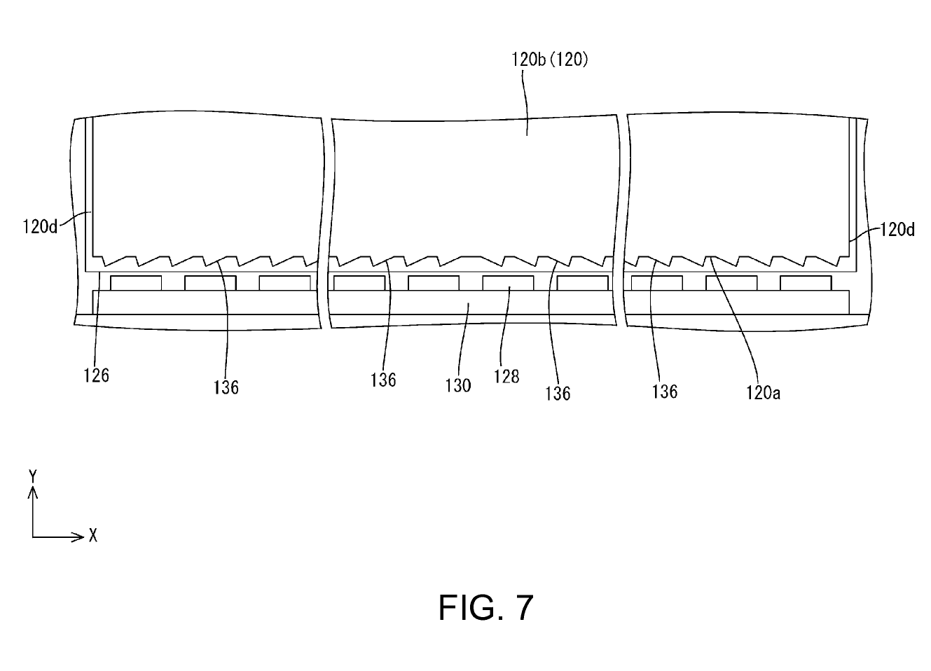

Embodiment 2 is described with reference to the drawings. The shapes of recesses or protrusions 136 provided on a light-entering face 120a in Embodiment 2 differ from those in Embodiment 1. Other configurations are similar to those of Embodiment 1; thus, the descriptions of the configurations, operation, and effects are omitted. Parts in FIG. 7 that have 100 added to the reference characters of FIG. 5 are the same as these parts described in Embodiment 1.

As shown in FIG. 7, in the backlight device according to Embodiment 2, the recesses or protrusions 136 provided on the light-entering face 120a of a light guide plate 120 have a configuration as if the recesses or protrusions 36 described in Embodiment 1 are inverted along the light-entering face 120a. In other words, each of the recesses or protrusions 136 is a prism lens that extends in the direction orthogonal to the surface of the light guide plate 120 and protrudes in a triangular shape toward the outer side of the light guide plate 120 in a plan view of the light guide plate 120. An apex of this triangular shape is shifted in position relatively toward either of the adjacent end faces 120d.

Regarding the two sides that form the apex of each of the recesses or protrusions 136 of the prism lens, the relationship between the length of the side located relatively toward either adjacent end faces 120d and the length of the side located relatively toward the center of the light-entering face 120a is identical to that described in Embodiment 1. For this reason, in the present embodiment, even when the recesses or protrusions 136 provided on the light-entering face 120a have the shapes described above, the light entering the light guide plate 120 from the light-entering face 120a travels toward either of the adjacent end faces 120d by virtue of the recesses or protrusions 136. As a result, even when the distance between adjacent LEDs 128 becomes shorter, the backlight device can inhibit the light from overlapping more in the center than in the edges of the light-entering face 120a and can prevent or inhibit the brightness between the center and the edges of the light-exiting surface 120b from becoming uneven, for example.

### Embodiment 3

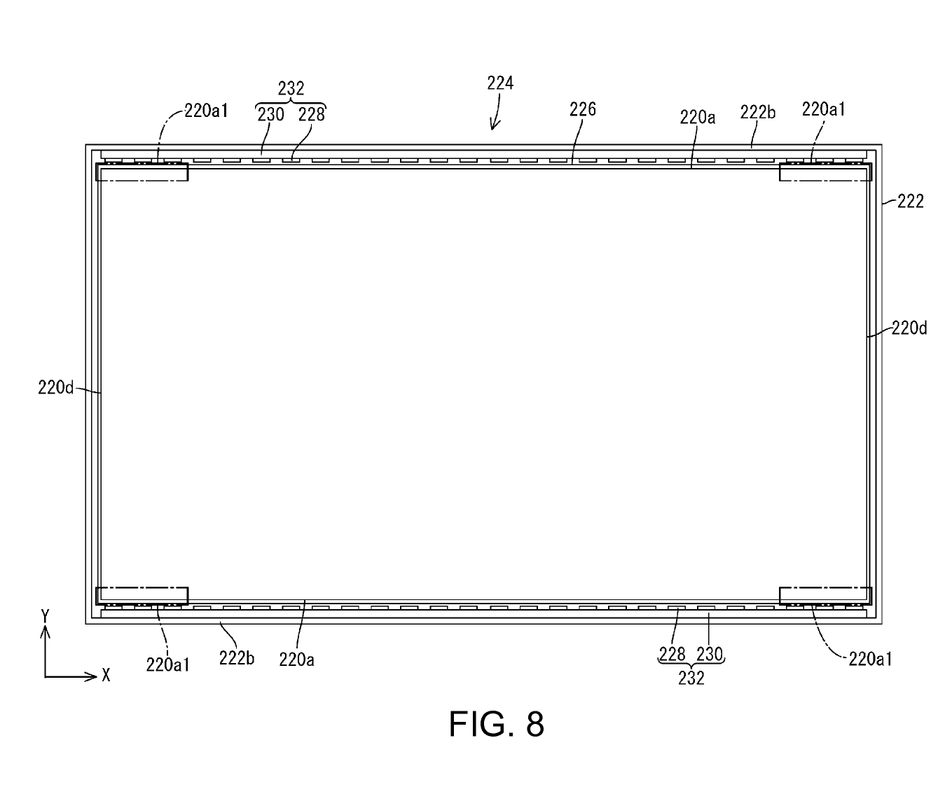

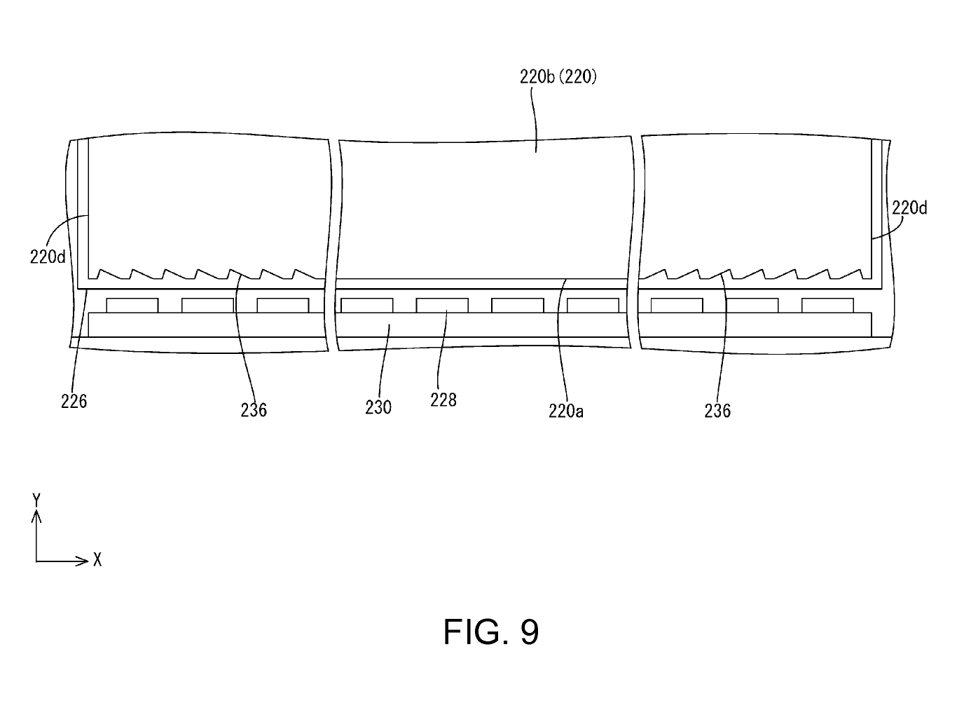

Embodiment 3 is described with reference to the drawings. Embodiment 3 differs from Embodiment 1 in that recesses or protrusions 236 are provided only on a part of a light-entering face 220a of a light guide plate 220. Other configurations are similar to those of Embodiment 1; thus, the descriptions of the configurations, operation, and effects are omitted. Parts in FIGS. 8 and 9 that have 200 added to the reference characters of FIGS. 4 and 5 are the same as these parts described in Embodiment 1.

As shown in FIGS. 7 and 8, in a backlight device 224 according to Embodiment 3, the recesses or protrusions 236 are provided only on portions 220a1 of the light-entering face 220a of the light guide plate 220 that are closer to either adjacent end faces 220d. The shapes of the recesses or protrusions 236 are the same as those described in Embodiment 1. According to the present embodiment, by the recesses or protrusions 236 being arranged on the light light-entering face 220a as described above, the light entering the portion of the light-entering face without the recesses or protrusions 236 propagates evenly toward either of the adjacent end faces 220d. In contrast, the light entering the light-entering face with the recesses or protrusions 236 propagates toward either of the adjacent end faces 220d. As a result, in a configuration in which the recesses or protrusions 236 are arranged as in the present embodiment, even when the distance between adjacent LEDs 228 becomes shorter, the backlight device can inhibit the light from overlapping more heavily in the center than in the edges of the light-entering face 220a and can prevent or inhibit the brightness between the center and the edges of the light-exiting surface 220b from becoming uneven, for example.

Also, in the present embodiment, the recesses or protrusions 236 are provided only on the parts of the light-entering face 220a that are relatively closer to either of the adjacent end faces 220d. Thus, compared to when forming the recesses or protrusions 236 on the entire surface of the light-entering face 220a, the manufacturing cost of the light guide plate 220 can be reduced.

### Embodiment 4

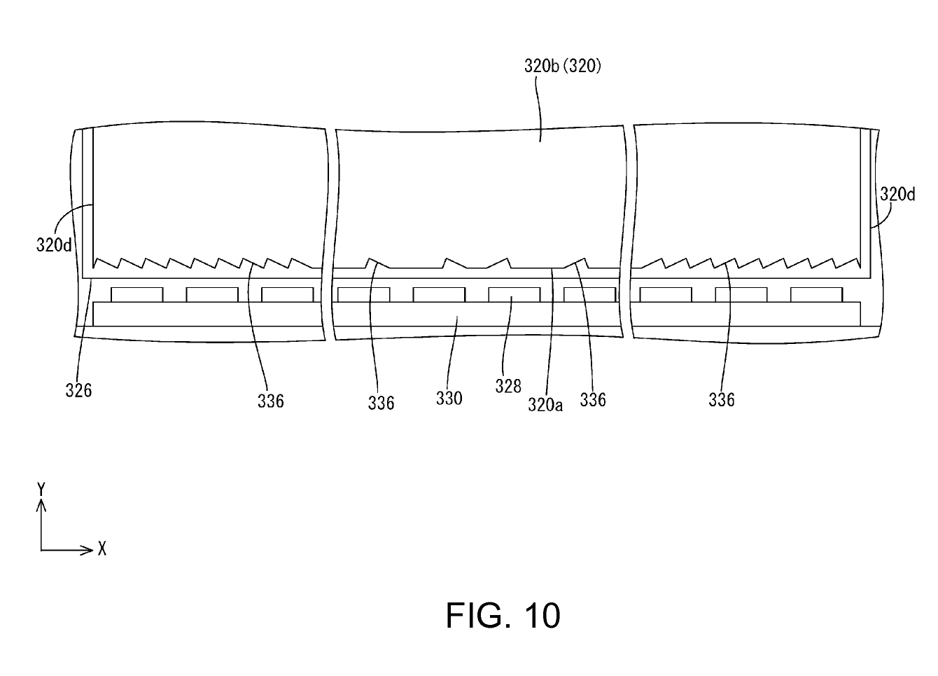

Embodiment 4 is described with reference to the drawings. The density of recesses or protrusions 336 that are provided on a light-entering face 320a of a light guide plate 320 in Embodiment 4 differs from that in Embodiment 1. Other configurations are similar to those of Embodiment 1; thus, the descriptions of the configurations, operation, and effects are omitted. Parts in FIG. 10 that have 300 added to the reference characters of FIG. 5 are the same as the corresponding parts described in Embodiment 1.

As shown in FIG. 10, in the backlight device according to Embodiment 4, the recesses or protrusions 336 are more densely provided relatively toward either adjacent end faces 320d of the light-entering face 320a than toward the center of the light-entering face 320a. By virtue of such a configuration, the present embodiment can guide even more of the light entering the light-entering face 320a relatively from the side of either of the adjacent end faces 320d rather than the center of the light-entering face 320a to travel toward the corresponding adjacent end faces 320d. Thus, the evenness of the brightness distribution in the light-exiting surface 320b can be improved more effectively.

Modification examples of the respective embodiments mentioned above are described below.

(1) Each of the embodiments described above used as an example a configuration in which some of the light entering the light-entering face of the light guide plate traveled, by virtue of the recesses or protrusions, toward one of the adjacent end faces, and some of the light traveled toward another of the adjacent end faces. However, a configuration in which the light entering the light-entering face travels toward at least one of the adjacent end faces by virtue of the recesses or protrusions may be used.

(2) In each of the embodiments described above, the shapes, the arrangement, and the like of the recesses or protrusions that are provided on the light-entering face of the light guide plate can be appropriately modified beyond those used in each of the embodiments described above.

(3) Although the respective embodiments described above used as an example a liquid crystal display device using a liquid crystal panel as a display panel, the present invention is also applicable to a display device that uses another type of display panel.

(4) In the respective embodiments above, a television receiver that includes a tuner was shown as an example, but the present invention is also applicable to a display device without a tuner.

The embodiments of the present invention were described above in detail, but these are only examples, and do not limit the scope as defined by the claims. The technical scope defined by the claims includes various modifications of the specific examples described above.

### DESCRIPTION OF REFERENCE CHARACTERS

TV television receiver
Ca, Cb cabinet
T tuner
S stand
10 liquid crystal display device
12 bezel
14 frame
16 liquid crystal panel
18 optical member
20, 120, 220, 320 light guide plate
20a, 120a, 220a, 320a light-entering face
20b, 120b, 220b, 320b light-exiting surface
22 chassis
24 backlight device
28, 128 LED
30, 130 LED substrate
32, 232 LED unit
36, 136, 236, 336 recesses or protrusions
36a apex

1: An illumination device, comprising:
a plurality of light-emitting diodes arranged in a row; and
a light guide plate having, on at least one end face thereof, a light-entering face into which light emitted from the plurality of light-emitting diodes enter, the light guide plate further having side faces that respectively abut said light-entering face,
wherein said light-entering face has a plurality of recesses or protrusions on at least a portion thereof, each of the plurality of recesses or protrusions having a shape of a prism that directs the light entering said prism toward one of said side faces that is closer to where said prism is located relative to a center of said light guide plate.

2: The illumination device according to claim 1,
wherein each of the recesses or protrusions is a prism lens that recesses in a triangular shape toward an inner side of said light guide plate in a plan view, said prism lens extending in a direction orthogonal to a surface of said light guide plate, and
wherein an apex of said triangular shape is shifted in position toward one of said side faces that is closer to where said apex is located.

3: The illumination device according to claim 1,
wherein each of the recesses or protrusions is a prism lens that protrudes in a triangular shape toward an outer side of said light guide plate in a plan view, said prism lens extending in a direction orthogonal to a surface of said light guide plate, and
wherein an apex of said triangular shape is shifted in position toward one of said side faces that is closer to where said apex is located.

4: The illumination device according to claim 2, wherein, in each of the recesses or protrusions, of two sides that constitute said apex of said triangular shape in said plan view of said light guide plate, a side located toward the one of said side faces that is closer to where said apex is located is shorter than a side located toward the center of said light guide plate.

5: The illumination device according to claim 1, wherein the plurality of recesses or protrusions are provided on an entire surface of said light-entering face.

6: The illumination device according to claim 5, wherein, in said light-entering face, the recesses or protrusions provided toward the respective side faces are more dense than the recesses or protrusions provided toward the center of said light-entering face.

7: The illumination device according to claim 1, wherein the recesses or protrusions are provided only on parts of said light-entering face located toward the respective side faces.

8: The illumination device according to claim 1, wherein said light guide plate is made of a resin.

9: The illumination device according to claim 1, wherein said plurality of light-emitting diodes are arranged along said light-entering face in a straight line at a substantially uniform interval.

10: A display device, comprising:
the illumination device according to claim 1; and
a display panel that performs display using light from said illumination device.

11: The display device according to claim 10, wherein said display panel is a liquid crystal panel that uses liquid crystal.

12: A television receiver device, comprising: the display device according to claim 10.

13: The illumination device according to claim 3, wherein, in each of the recesses or protrusions, of two sides that constitute said apex of said triangular shape in said plan view of said light guide plate, a side located relatively toward the one of said side faces that is closer to where said apex is located is shorter than a side located toward the center of said light guide plate.
